(19) United States
(12) Patent Application Publication
(10) Pub. No.: US 2026/0106390 A1
(43) Pub. Date: Apr. 16, 2026

(54) GUIDE, BOARD CARD ASSEMBLY AND CONNECTOR ASSEMBLY

(71) Applicant: Tyco Electronics (Shanghai) Co., Ltd., Shanghai (CN)

(72) Inventors: Zongjie (Jason) Tao, Shanghai (CN); Jingtao (Murphy) Zhu, Shanghai (CN); David (Xinjie) Zhang, Shanghai (CN); Xin (Sunny) Song, Shanghai (CN)

(73) Assignee: Tyco Electronics (Shanghai) Co., Ltd., Shanghai (CN)

(21) Appl. No.: 19/353,829

(22) Filed: Oct. 9, 2025

(30) Foreign Application Priority Data
Oct. 10, 2024 (CN) 202411413708.X

(51) Int. Cl. H01R 12/70; H01R 12/55; H01R 12/72; H01R 13/24; H01R 13/50

(52) U.S. Cl. CPC H01R 12/7005; H01R 12/55; H01R 12/721; H01R 13/2414; H01R 13/50

(57) ABSTRACT

A guide includes a front side having a cross-section with a triangular shape or a trapezoidal shape with a narrow front and a wide back. The guide is fitted onto a board card and guides a front side of the board card between a plurality of elastic contact portions of a pair of rows of terminals of a connector.

### CROSS-REFERENCE TO RELATED APPLICATION

This application claims the benefit of the filing date under 35 U.S.C. § 119(a)-(d) of Chinese Patent Application No. 202411413708.X, filed on Oct. 10, 2024.

### FIELD OF THE INVENTION

The present invention relates to a guide and, more particularly, to a guide, a board card assembly comprising the guide, and a connector assembly comprising the board card assembly.

### BACKGROUND OF THE INVENTION

A connector that is used to mate with a board card typically includes a housing and two rows of terminals provided in the housing. The board card is inserted between the elastic contact portions of the two rows of terminals to make electrical contact with the two rows of terminals of the connector. The elastic contact portion of the terminal includes a protrusion that makes electrical contact with the board card and a guide leading end that extends obliquely from the protrusion. The guide leading ends of the two rows of terminals are used to guide the insertion of the board card between the protrusions of the two rows of terminals. Therefore, even if there is some deviation in the insertion position of the board card, it can be smoothly inserted between the protrusions of the two rows of terminals under the guidance of the guiding ends of the two rows of terminals.

It has been experimentally proven that the guide leading end of the terminal will reduce the signal integrity of the connector. Sometimes the guide leading end of the terminal is removed to improve the signal integrity of the connector. However, removing the guide leading end of the terminal will affect the insertion of the board card into the connector. The front side of the board card is likely to be pushed against the front end of the elastic contact portion of the terminal, which can cause the terminals of the connector to be damaged by the inserted board card.

### SUMMARY OF THE INVENTION

A guide includes a front side having a cross-section with a triangular shape or a trapezoidal shape with a narrow front and a wide back. The guide is fitted onto a board card and guides a front side of the board card between a plurality of elastic contact portions of a pair of rows of terminals of a connector.

### BRIEF DESCRIPTION OF DRAWINGS

The invention will now be described by way of example with reference to the accompanying figures, of which:

FIG. 1 is an exploded view of a board card assembly according to an exemplary embodiment;

FIG. 2 is an assembly view of the board card assembly of FIG. 1;

FIG. 3 is a horizontal sectional view of the board card assembly of FIG. 1, where a guide of the board card assembly has not yet been assembled onto a board of the board card assembly;

FIG. 4 is a horizontal sectional view of the board card assembly of FIG. 1, in which the guide of FIG. 3 has been assembled onto the board of FIG. 3;

FIG. 5 is a vertical sectional view of the board card assembly of FIG. 1, where the guide of FIG. 3 has not yet been assembled onto the board of FIG. 3;

FIG. 6 is a vertical sectional view of the board card assembly of FIG. 1, in which the guide of FIG. 3 has been assembled onto the board of FIG. 3;

FIG. 7 is another vertical sectional view of the board card assembly of FIG. 1, where the guide of FIG. 3 has not yet been assembled onto the board of FIG. 3;

FIG. 8 is another vertical sectional view of the board card assembly of FIG. 1, in which the guide of FIG. 3 has been assembled onto the board of FIG. 3;

FIG. 9 is an exploded view of a connector assembly according to an exemplary embodiment;

FIG. 10 is an assembly view of the connector assembly of FIG. 9;

FIG. 11 is a vertical sectional view of the connector assembly of FIG. 9, where the board card assembly of FIG. 1 of the connector assembly has not yet been inserted into a connector of the connector assembly;

FIG. 12 is a vertical sectional view of the connector assembly of FIG. 9, where the board card assembly of FIG. 1 has been inserted into the connector of FIG. 11;

FIG. 13 is another vertical sectional view of the connector assembly of FIG. 9, where the board card assembly of FIG. 1 has not yet been inserted into the connector of FIG. 11;

FIG. 14 is another vertical sectional view of the connector assembly of FIG. 9, in which the board card assembly of FIG. 1 has been inserted into the connector of FIG. 11;

FIG. 15 is another vertical sectional view of the connector assembly of FIG. 9, where terminals of the connector of FIG. 11 are shown and the board card assembly of FIG. 1 has not yet been inserted into the connector;

FIG. 16 is another vertical sectional view of the connector assembly of FIG. 9, where the terminals of FIG. 15 of the connector of FIG. 11 are shown and the board card assembly of FIG. 1 has been inserted into the connector;

FIG. 17 is a sectional plan view of mating the board card assembly of FIG. 1 with two rows of terminals of the connector of FIG. 11, where the board card of FIG. 3 has not yet been inserted between the two rows of terminals;

FIG. 18 is a sectional plan view of mating the board card assembly of FIG. 1 with the two rows of terminals of FIG. 17 of the connector of FIG. 11, where the board card of FIG. 3 has been inserted between the two rows of terminals;

FIG. 19 is a sectional plan view of mating a board card with two rows of terminals of a connector in the prior art, where the prior art board card has not yet been inserted between the two rows of terminals; and

FIG. 20 is a sectional plan view of mating the board card of FIG. 19 with the two rows of terminals of FIG. 19 of the connector in the prior art of FIG. 19, where the prior art board card of FIG. 19 has been inserted between the two rows of terminals of the prior art.

### DETAILED DESCRIPTION

Exemplary embodiments of the present disclosure will be described hereinafter in detail with reference to the attached drawings, wherein like reference numerals refer to like elements. The present disclosure may, however, be embodied in many different forms and should not be construed as being limited to the embodiments set forth herein; rather, these embodiments are provided so that the present disclosure will convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

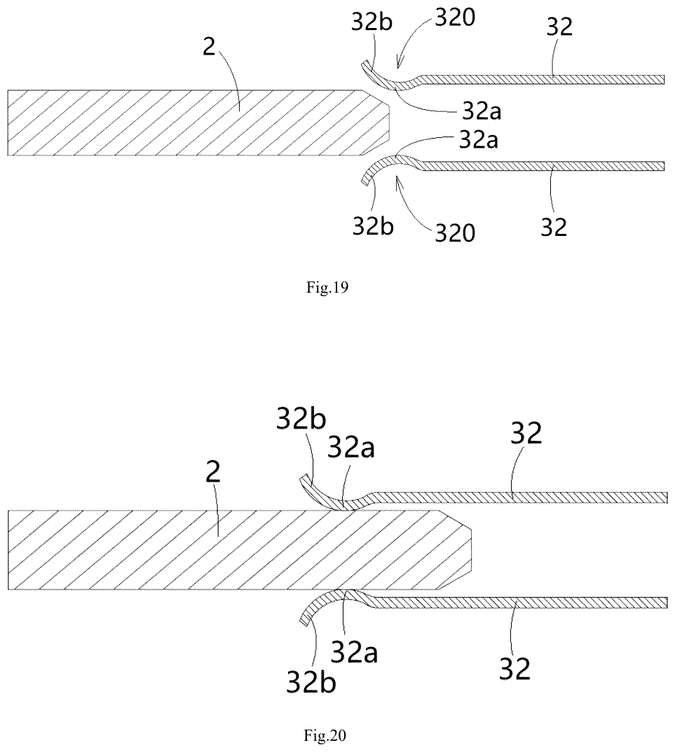

FIGS. 19-20 show a prior art board card 2 and a prior art connector. As shown in FIGS. 19-20, in the prior art, the elastic contact portion 320 of the terminal 32 includes a protrusion 32a that is in electrical contact with the board card 2, and a guide leading end 32b that extends obliquely from the protrusion 32a. The guide leading ends 32b of the two rows of terminals 32 are used to guide the board card 2 to be inserted between the protrusions 32a of the two rows of terminals 32. Therefore, even if there is some deviation in the insertion position of the board card 2, it can still be smoothly inserted between the protrusions 32a of the two rows of terminals 32 under the guidance of the guide leading end 32b. However, it has been experimentally proven that the guide leading end 32b of the terminal 32, which is located at the leading end of the terminal 32, will reduce the signal integrity of the connector.

In the prior art, sometimes in order to improve the signal integrity of the connector, the guide leading end 32b of the terminal 32 is removed. However, removing the guide leading end 32b of the terminal 32 will affect the insertion of the board card 2 into the connector, and the front side of the board card 2 is likely pushed against the front end of the elastic contact portion 320 of the terminal 32, which will cause the terminal 32 of the connector to be damaged by the inserted board card 2.

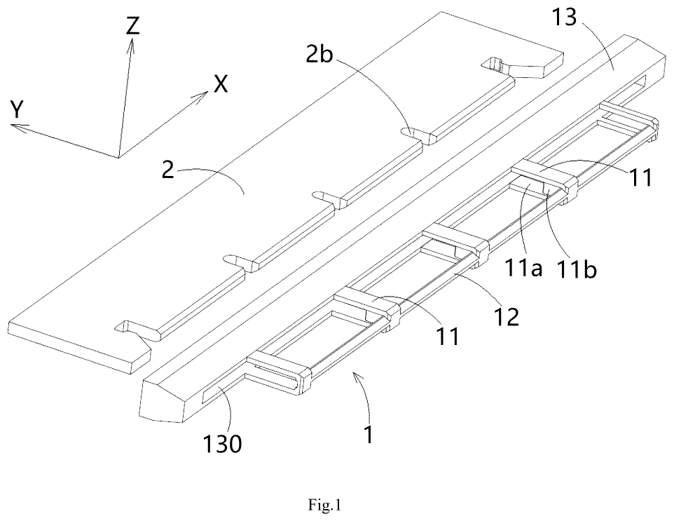

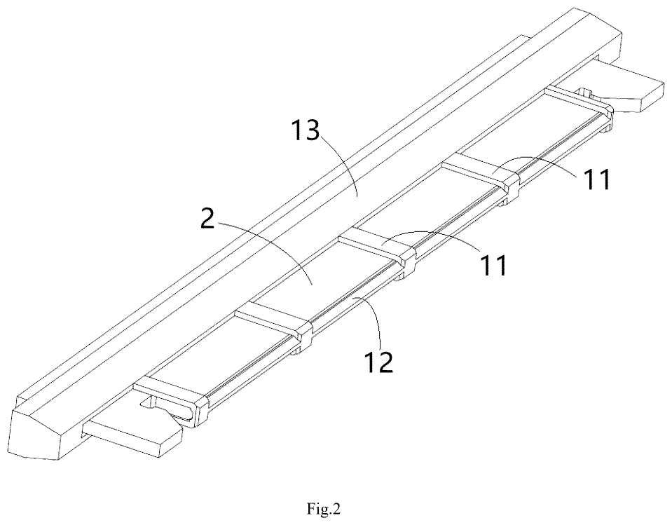

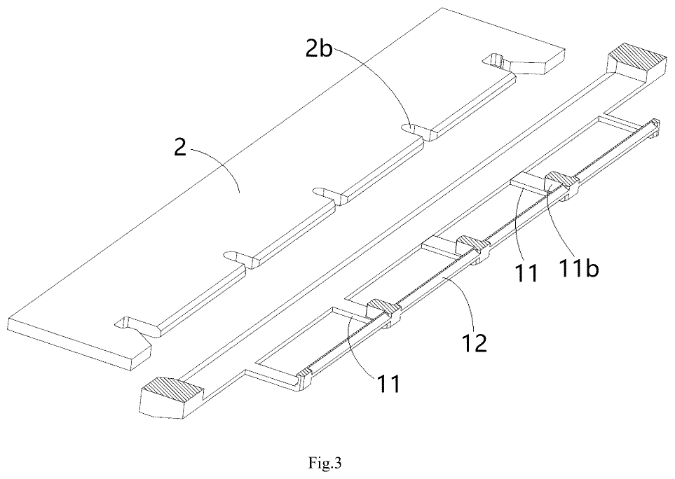

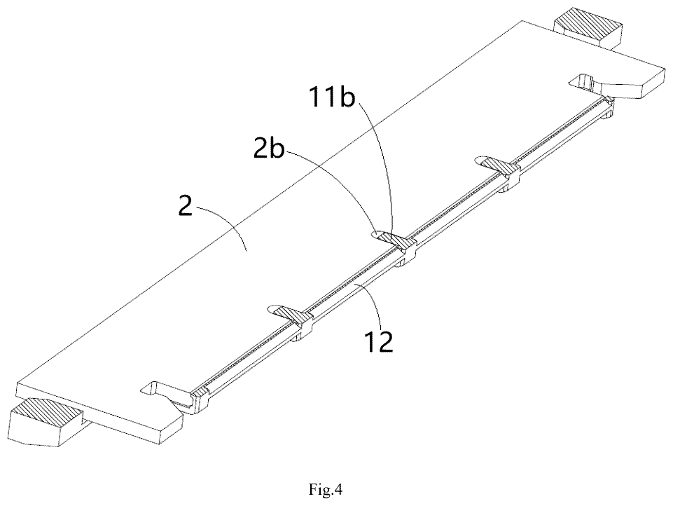

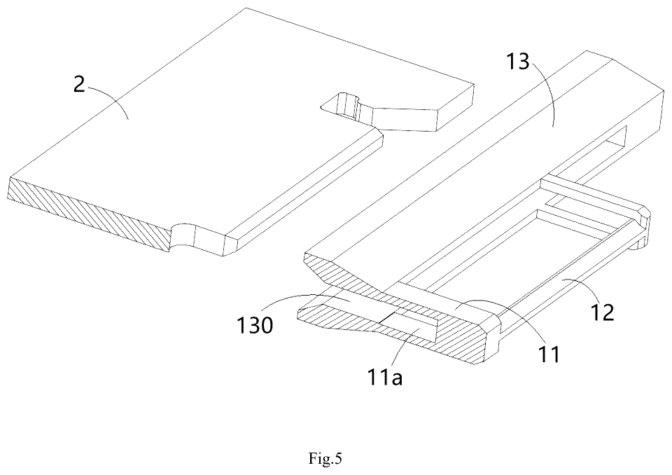

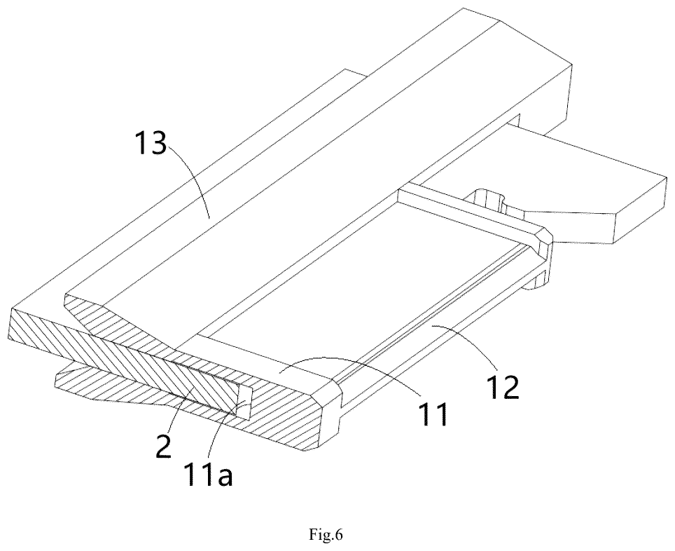

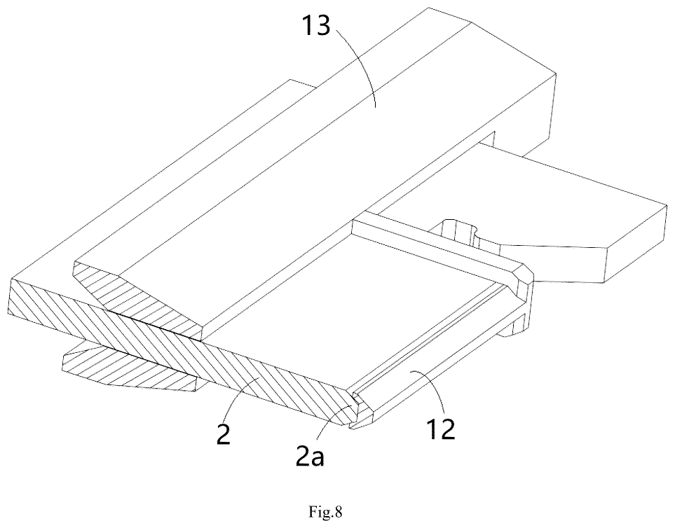

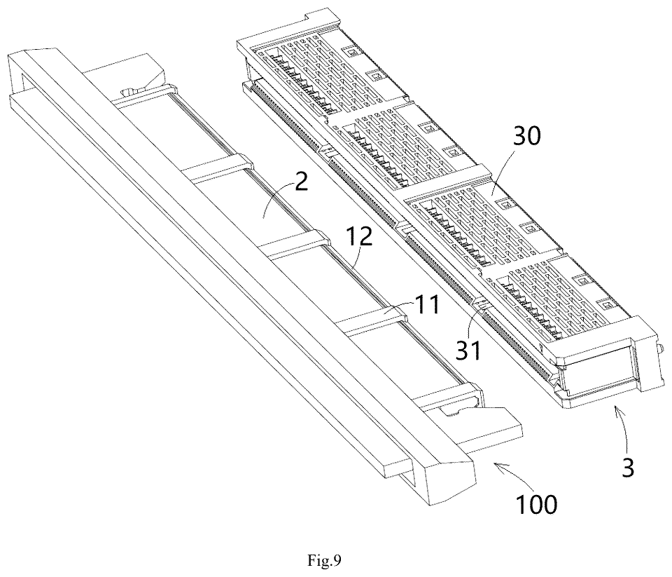

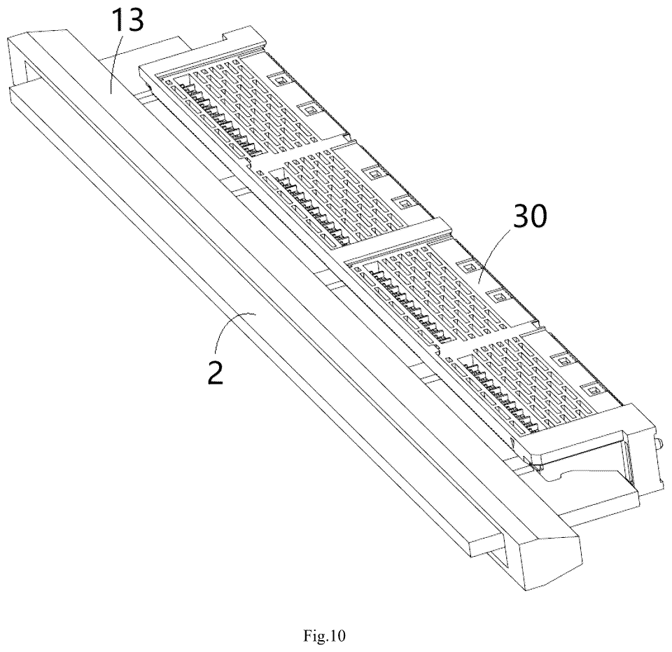

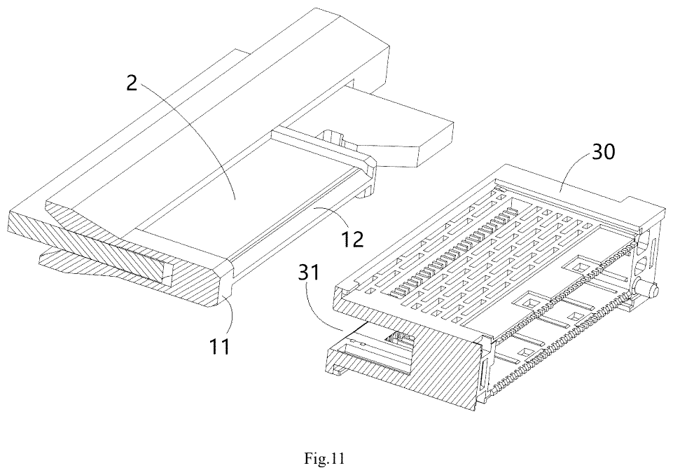

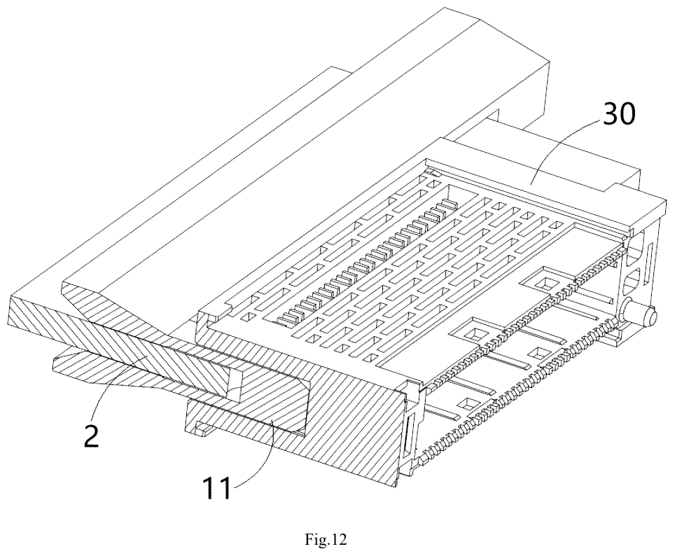

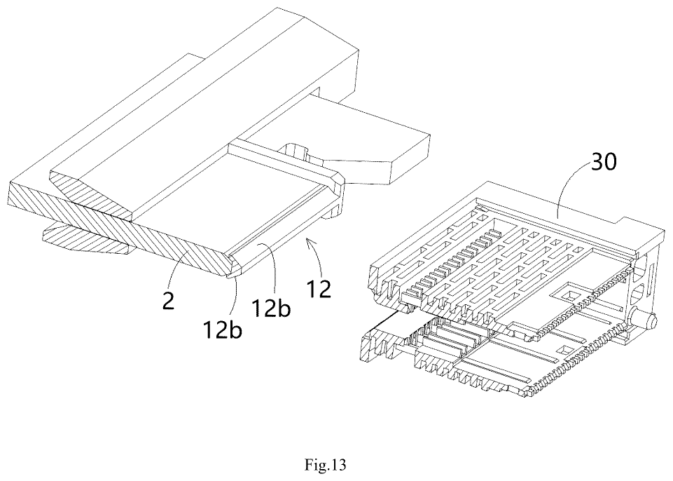

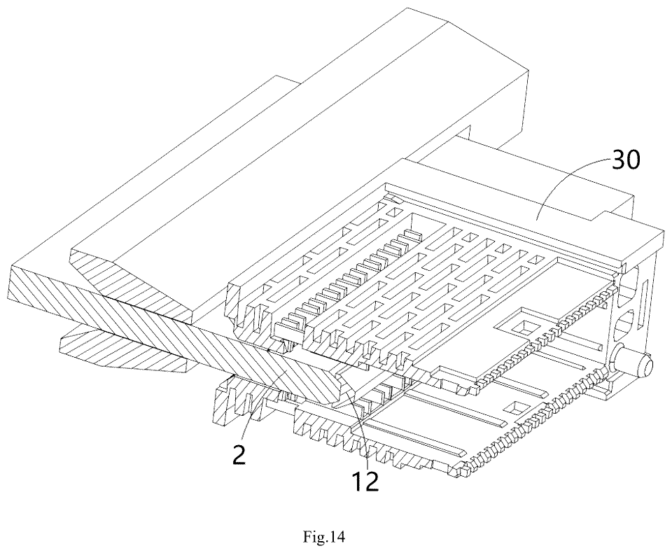

An exemplary embodiment of a guide 1 (or also referred to as a guide member 1) will now be described with reference to FIGS. 1-18. As shown in FIGS. 1-3, 5-6, 9, and 11, the guide 1 includes multiple guide ribs 11 and a guide bar 12. The multiple guide ribs 11 extend along the longitudinal direction Y and are spaced apart (e.g., distributed at intervals) in the transverse direction X perpendicular to the longitudinal direction Y. The guide bar 12 is connected to the front ends of the multiple guide ribs 11 and extends along the transverse direction X. A slot 11a, as shown in FIGS. 1 and 5, is formed in the rear end of the guide rib 11 to allow the board card 2 to be inserted along the longitudinal direction Y, so that the guide 1 can be fitted onto the front side of the board card 2. The guide rib 11 is used to mate with a guide slot 31 inside the housing 30 of the connector 3, as shown in FIGS. 9 and 11, to guide the guide 1 into the housing 30 of the connector 3. The cross-section of the guide bar 12 is a triangle or trapezoid with a narrow front and wide back, which guides the front side of the board card 2 to be inserted between the elastic contact portions 320 of the two rows of terminals 32 of the connector 3. In other words, a cross-section of the guide bar 12 has a triangular or a trapezoidal shape with a narrow front and a wide back. Additionally, a cross-section of a front side of the guide 1 has a triangular or a trapezoidal shape with a narrow front and a wide back.

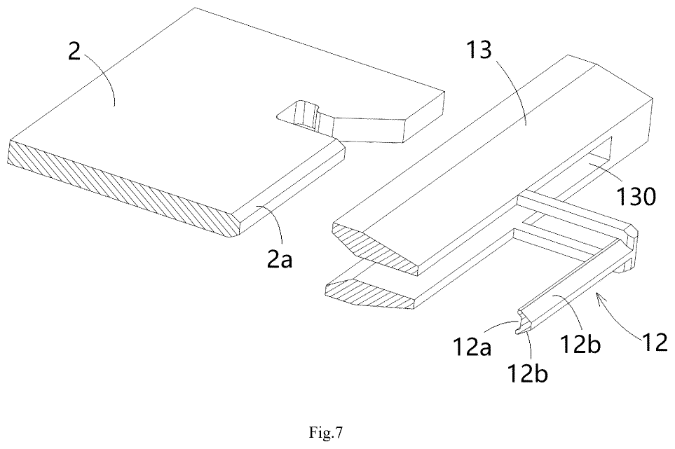

The guide bar 12 has upper and lower sides opposite in the height direction Z perpendicular to the longitudinal direction Y and the transverse direction X, and front and rear sides that are opposite in the longitudinal direction Y. Guide slopes 12b, as shown in FIGS. 7, 13, and 17, are formed on the upper and lower sides of the guide bar 12, respectively. The guide slopes 12b on the upper and lower sides of the guide bar 12 are symmetrically arranged on the upper and lower sides of the guide bar 12, so that the cross-section of the guide bar 12 is an isosceles triangle or an isosceles trapezoid. In other words, the cross-section of the guide bar 12 has an isosceles triangle shape or an isosceles trapezoid shape. Additionally, the guide slope 12b extend obliquely between the front and rear sides of the guide bar 12, and the angle between the guide slopes 12b on the upper and lower sides of the guide bar 12 is greater than zero degrees and less than 45 degrees. For example, the angle between the upper and lower guide slopes 12b of the guide bar 12 can be equal to 20 degrees or 30 degrees.

As shown in FIG. 7, a concave portion 12a suitable for engaging with the front edge 2a of the board card 2 is formed on the rear side of the guide bar 12.

As shown in FIGS. 1 and 3-4, a positioning tongue 11b is formed in the slot 11a of at least one of the multiple guide ribs 11. The positioning tongue 11b is used to engage with a positioning slot 2b in the board card 2.

As shown in FIGS. 1-2, and 5-6, the guide 1 further comprises an outer shell 13, which is connected to the rear ends of multiple guide ribs 11. An inner cavity 130, as shown in FIGS. 1 and 5, suitable for mating with the board card 2 is formed in the outer shell 13, allowing the outer shell 13 to be fitted onto the main body of the board card 2. The two inner sides of the inner cavity 130 of the outer shell 13 that are opposite in the height direction Z are used to respectively press against the upper and lower surfaces of the main body of the board card 2, in order to position the board card 2 in the height direction Z. However, the present invention is not limited to the illustrated embodiment, for example, the outer shell 13 of the guide 1 may be omitted.

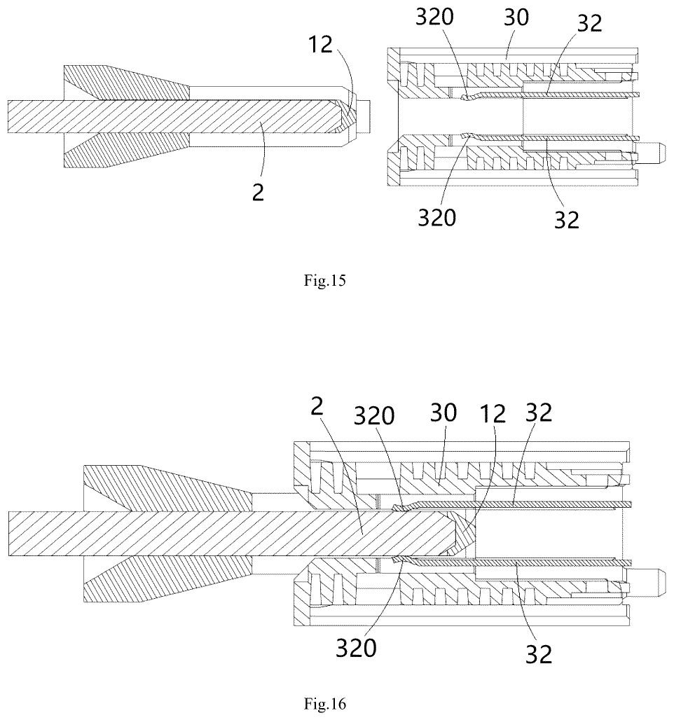

An exemplary embodiment of a board card assembly 100 will now be described with reference to FIGS. 1-18. As shown in FIG. 1, the board card assembly 100 includes a board card 2 and the guide 1. The guide 1 is assembled onto the board card 2. The cross-section of the guide bar 12 of the guide 1 is a triangle or trapezoid with a narrow front and wide back. As shown in FIGS. 16 and 18, the guide 1 is used to guide the front side of the board card 2 to be inserted between the elastic contact portions 320 of the two rows of terminals 32 inside the housing 30 of the connector 3.

As shown in FIG. 8, the front edge 2a of the board card 2 is engaged into the inner concave portion 12a on the rear side of the guide bar 12.

As shown in FIG. 1, and 3-4, multiple positioning slots 2b corresponding to multiple guide ribs 11 are formed on the board card 2. At least one of the multiple positioning slots 2b is engaged with the positioning tongue 11b on the guide 1.

A row of contact pads is formed on each of the top and bottom sides of the front side of board card 2. The row of contact pads on the top side of board card 2 are used for electrical contact with the elastic contact portions 320 of one row of terminals 32 of the connector 3, and the row of contact pads on the bottom side of the front side of board card 2 is used for electrical contact with the elastic contact portion 320 of the other row of terminals 32 of connector 3.

An exemplary embodiment of a connector assembly will now be described with reference to FIGS. 1-18. The connector assembly includes a connector 3 and the board card assembly 100. As shown in FIGS. 15-16, the connector 3 includes a housing 30 and two rows of terminals 32. The two rows of terminals 32 are set in the housing 30. The board card assembly 100 is inserted into the housing 30. As shown in FIGS. 16 and 18, the front side of board card 2 is inserted between the elastic contact portions 320 of the two rows of terminals 32 under the guidance of the guide bar 12 of guide 1, to make electrical contact with the two rows of terminals 32.

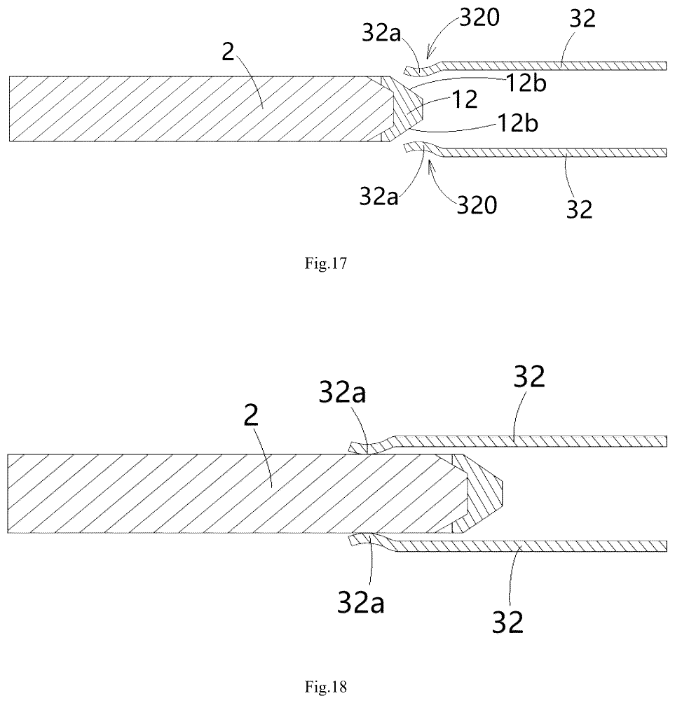

The elastic contact portion 320 of the terminal 32 has a protrusion 32a, as shown in FIGS. 17-18, that makes electrical contact with the board card 2. The terminal 32 does not have a guide leading end 32b that extends obliquely from the protrusion 32a that is used to guide the front side of the board card 2 to be inserted between the protrusions 32a of the two rows of terminals 32.

As shown in FIG. 9, multiple guide slots 31 are formed in the housing 30, which extend along the longitudinal direction Y of the housing 30 and are spaced apart in the transverse direction X of the housing 30. Multiple guide ribs 11 on the guide 1 respectively mate with multiple guide slots 31 in the housing 30 to guide the insertion of guide 1 and board card 2 into the housing 30.

As shown in FIGS. 15-18, two rows of terminals 32 are opposite in the height direction Z of the housing 30. The elastic contact portions 320 of the upper row of terminals 32 are in electrical contact with the row of contact pads on the top side of the board card 2, and the elastic contact portions 320 of the lower row of terminals 32 are in electrical contact with the row of contact pads on the bottom side of the front side of the board card 2.

In the aforementioned exemplary embodiments according to the present invention, the guide 1 fitted on the board card 2 can ensure the smooth insertion of the board card 2 between the elastic contact portions 32a of two rows of terminals 32 of the connector 3, effectively avoiding the problem of the terminals 32 of the connector 3 of being damaged by the inserted board card 2.

It should be appreciated for those skilled in this art that the above embodiments are intended to be illustrative, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

1. A guide, comprising:
a front side having a cross-section with a triangular shape or a trapezoidal shape with a narrow front and a wide back, the guide is fitted onto a board card and guides a front side of the board card between a plurality of elastic contact portions of a pair of rows of terminals of a connector.

2. The guide of claim 1, further comprising a plurality of guide ribs and a guide bar, the plurality of guide ribs extend along a longitudinal direction and are distributed at intervals in a transverse direction perpendicular to the longitudinal direction, the guide bar is connected to front ends of the plurality of guide ribs and extends along the transverse direction.

3. The guide of claim 2, wherein a slot is formed in a rear end of each guide rib to allow the board card to be inserted along the longitudinal direction, so that the guide can be fitted onto the front side of the board card.

4. The guide of claim 3, wherein each guide rib mates with a guide slot inside a housing of the connector to guide the guide into the housing of the connector, a cross-section of the guide bar has a triangular shape or a trapezoidal shape with a narrow front and wide back, to guide the front side of the board card between the elastic contact portions of the pair of rows of terminals of the connector.

5. The guide of claim 2, wherein the guide bar has an upper side and a lower side opposite the upper side in a height direction perpendicular to the longitudinal direction and the transverse direction, a plurality of guide slopes are formed on the upper side and the lower side of the guide bar.

6. The guide of claim 5, wherein the guide slope formed on the upper side of the guide bar and the guide slope formed on the lower side of the guide bar are symmetrically arranged on the upper side and the lower side of the guide bar, so that a cross-section of the guide bar has an isosceles triangle shape or an isosceles trapezoid shape.

7. The guide of claim 5, wherein the guide bar has a front side and a rear side that are opposite in the longitudinal direction, the guide slopes extend obliquely between the front side and the rear side of the guide bar, an angle between the guide slope on the upper side of the guide bar and the guide slope on the lower side of the guide bar is greater than zero degrees and less than 45 degrees.

8. The guide of claim 7, wherein a concave portion is formed on the rear side of the guide bar, the concave portion engages a front edge of the board card.

9. The guide of claim 3, wherein a positioning tongue is formed in the slot of at least one of the guide ribs, the positioning tongue engages with a positioning slot in the board card.

10. The guide of claim 2, further comprising an outer shell connected to a plurality of rear ends of the plurality of guide ribs, an inner cavity mating with the board card is formed in the outer shell, so that the outer shell is fitted onto a main body of the board card.

11. The guide of claim 10, wherein the inner cavity of the outer shell has a pair of inner sides that are opposite in a height direction, the pair of inner sides are respectively pressed against an upper surface and a lower surface of the main body of the board card to position the board card in the height direction.

12. A board card assembly, comprising:
a board card; and
a guide fitted onto the board card and having a guide bar, a cross-section of the guide bar has a triangular shape or a trapezoidal shape with a narrow front and wide back, to guide a front side of the board card between a plurality of elastic contact portions of a pair of rows of terminals inside a housing of a connector.

13. The board card assembly of claim 12, wherein a front edge of the board card is engaged into a concave portion in a rear side of the guide bar.

14. The board card assembly of claim 12, wherein a plurality of positioning slots, respectively corresponding to a plurality of guide ribs of the guide, are formed in the board card, at least one of the plurality of positioning slots is engaged with a positioning tongue formed in a slot of at least one of the guide ribs.

15. The board card assembly of claim 12, wherein a row of contact pads is formed on each of a top side and a bottom side of a front side of the board card, the row of contact pads on the top side of the board card electrically contact the elastic contact portions of one row of terminals of the connector, and the row of contact pads on the bottom side of the front side of the board card electrically contact the elastic contact portions of the other row of terminals of the connector.

16. A connector assembly, comprising:
a connector including a housing and a pair of rows of terminals arranged in the housing; and
a board card assembly including a board card and a guide fitted onto the board card and having a guide bar, a cross-section of the guide bar has a triangular shape or a trapezoidal shape with a narrow front and wide back, the board card assembly is inserted into the housing, a front side of the board card is inserted between a plurality of elastic contact portions of the pair of rows of terminals under a guidance of the guide bar of the guide to electrically contact the pair of rows of terminals.

17. The connector assembly of claim 16, wherein the elastic contact portion of each terminal has a protrusion that electrically contacts the board card, the terminal does not have a guide leading end that extends obliquely from the protrusion that guides the front side of the board card to be inserted between the protrusions of the two rows of terminals.

18. The connector assembly of claim 16, wherein a plurality of guide slots are formed in the housing, each guide slot extends along a longitudinal direction of the housing and is spaced apart in a transverse direction of the housing, a plurality of guide ribs on the guide each mate with one guide slot to guide an insertion of the guide and the board card into the housing.

19. The connector assembly of claim 16, wherein the two rows of terminals are opposite in a height direction of the housing, the elastic contact portions of an upper row of terminals of the two rows of terminals electrically contact a row of contact pads on a top side of a front side of the board card, the elastic contact portions of a lower row of terminals of the two rows of terminals electrically contact a row of contact pads on a bottom side of a front side of the board card.
